(19) United States
(12) Patent Application Publication
(10) Pub. No.: US 2003/0066843 A1
(43) Pub. Date: Apr. 10, 2003

(54) Triangular feed system with external bottle

(75) Inventor: Barry Richard Schwartz, Baton Rouge, LA (US)

Correspondence Address: Barry R. Schwartz, 1453 Millerville Road, Baton Rouge, LA, 70816, US

(73) Assignee: Barry Richard Schwartz

(21) Appl. No.: 09/928,979

(22) Filed: Aug. 13, 2001

(51) Int. Cl. B67D 5/40; B67D 5/60

(52) U.S. Cl. 222/377; 222/382; 222/464.7

(57) ABSTRACT

A fluid dispenser bottle of an upright variety having a pump dispenser (spout or spray nozzle) at the upper end thereof wherein provided in the interior base of such a bottle as to direct the contents into one corner or the opposite corner (depending on which side the lowest point of the triangle is placed, to the base of said bottle and being drawn out by a tube engaging at the lowest point of said triangle, to permit the contents of the bottle to flow into the lowest point of the triangular shaped devise.

### (A) BACKGROUND OF THE INVENTION

1. Field of Invention

The present invention relates to dispenser bottles and more particularly per tains to such bottles which have a dispenser pump at the upper end thereof.

2. Description of Prior Art

The use of dispenser pump type bottle is known in the prior art. More specifically, bottles heretofore devised and utilized for the purpose of dispensing fluids therefrom are know to consist basically or familiar, expected and obvious structural configurations, not withstanding the myriad of designs encompassed by the crowded prior art which have been developed for the fulfillment of countless objectives and requirements. Typical of these are U.S. Pat. Nos. 5,366,119; 5,083,683; 5,062549; 4,759,475; 4,470,526; 3,282,510 and 3,083,875.

Where the fluids to be dispensed are at all viscous, such as ketchup, mustard, soaps, or the like, the convenient top-mounted dispenser invariably fails to completely empty such contents. Even with less vicious fluids, such as window cleaner, bath tub cleaner, or the like some usually remains.

In this respect, the dispenser bottle according to the present invention substantially departs from the conventional concepts and designs of the prior art, and in so doing provides an apparatus primarily developed for the purpose of completely discharging the entire contents thereof.

Therefore, it can be appreciated that there exists a continuing need for a new and improved dispenser bottle which can be easily and completely emptied. In this regard, the present invention substantially fulfill this need.

### (B) SUMMARY OF THE INVENTION

In view of the foregoing disadvantages inherent in the known types of dispensers now present in the prior art, the present invention provides an improved dispenser bottle construction wherein the same can be utilized to completely empty the contents scribed subsequently in greater detail, is to provide a new and improved dispenser bottle which has all the advantages of the prior art dispensers and none of the disadvantages.

To attain this, the present invention essentially is comprised of a fluid dispenser bottle of the upright variety having a pump dispenser (spout or spray nozzle), and at the bottom of the bottle the present invention provides an improved dispenser bottle construction, wherein the flow directing means are provided in the interior lower portion of the bottle so as to direct the contents to the lowest most point as such base; a draw tube or straw engaging upwardly from this lowest most point permits the contents of such bottle to be completely drawn out.

This has been outlined, rather broadly, so that the more important features of the invention in order that the detailed description thereof that follows may be better understood, and in order that the present contribution of the art be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of the construction and to the arrangements of the components set forth in the following description or illustrated in the drawings. The invention is capable of other embodiments and of being practiced and carried out in various ways. Also, it is understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the forgoing abstract is to enable the U.S. Patent and Trademark Office and the public generally, and especially the scientists, engineers and the practitioners in the art who are not familiar with the patent or legal terms or phraseology, to determine quickly from a cursory inspection the nature and essence of the technical disclosure of the application.

The abstract is neither intended to define the invention of this application, which is measured by the claims, nor is it intended the limiting as to the scope of the invention in any way.

It is therefore an object of the present invention to provide a new and improved dispenser bottle which has all the advantages of the prior art dispensers and none of the disadvantages.

It is another objective of the present invention to provide a new and improved dispenser bottle which may be easily manufactured and marketed.

It is a further objective of the present invention is to provide a new and improved dispenser bottle which is of a durable and reliable construction.

An even further object of the present invention is to provide a new and improved bottle which is susceptible of low cost of manufacture with regard to both materials and labor, and which accordingly is then susceptible of less waste of product inside to the consuming public, thereby making such dispenser bottles in higher demand to the buying public.

Still another objective of the patent invention is to provide a new an improved bottle which provides in the apparatuses and methods of the prior art some of the advantages thereof, while simultaneously overcoming some of the disadvantages normally associated therewith.

A further object of the present invention is to provide a new and improved upright dispenser bottle.

Another object of the invention is to provide a new and improved upright dispenser bottle for viscous fluids.

A final object of the present invention is to provide a new and improved upright dispenser bottle which will discharge its entire contents.

These together with other objects of the invention, along with the various features of novelty which characterize the invention, are pointed out with particularity in the claims annexed to and forming a part of this disclosure. For a better understanding of the invention, its operating advantages and the specific objectives attained by its uses, reference should be made to the accompanying drawings and descriptive matter in which there is illustrated preferred embodiments of the invention.

### (C) BRIEF DESCRIPTION OF THE DRAWINGS

The invention will be better understood and objectives other than those set forth before will be apparent when consideration is given to the following detailed description thereof. Such description makes reference to the annexed drawings wherein.

FIG. 1 is a cut away side view of the standard triangular feed system with a flat platform.

FIG. 2 is a cut away side view of the triangular feed system with the convex platform.

FIG. 3 is a cut away side view of the triangular feed system with the concave platform.

FIG. 4 is a three dimensional sectional view of the triangular feed system with the standard flat platform.

FIG. 5 shows some of the types of sprayer tops that may be used in conjunction with the triangular feed system.

### (D) DETAILED DESCRIPTION OF THE INVENTION OR (D) BEST MODE FOR CARRYING OUT INVENTION

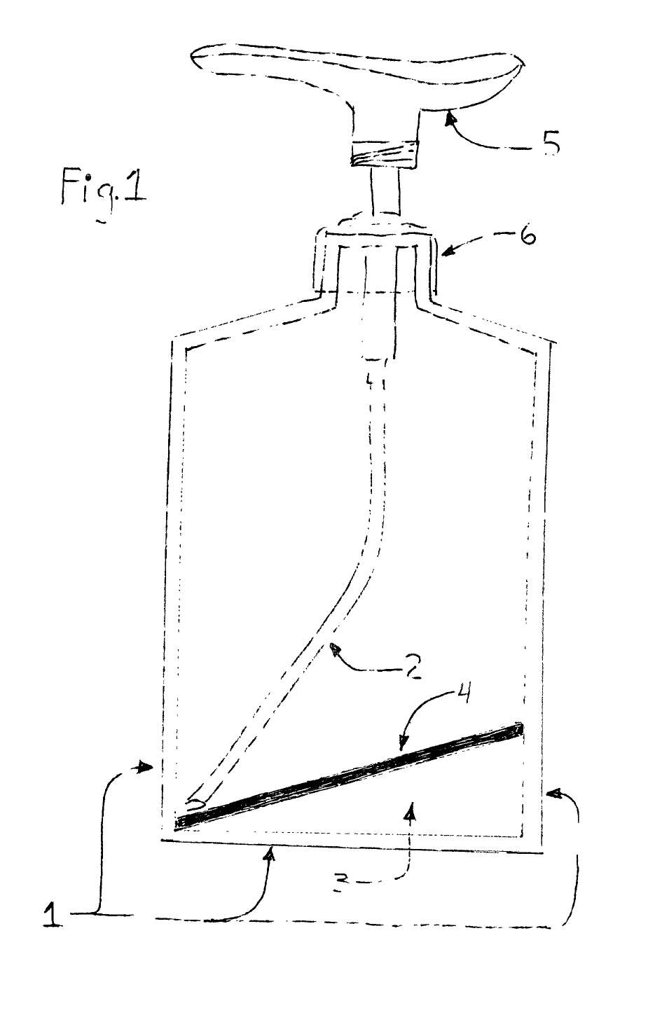

With reference now to the drawings, and now in particular to FIG. 1 thereof, a new and improved dispenser bottle embodying the principles and concepts of the present invention and generally designated by the reference numerals 1, 2, 3, 4, 5 and 6 will be described later on.

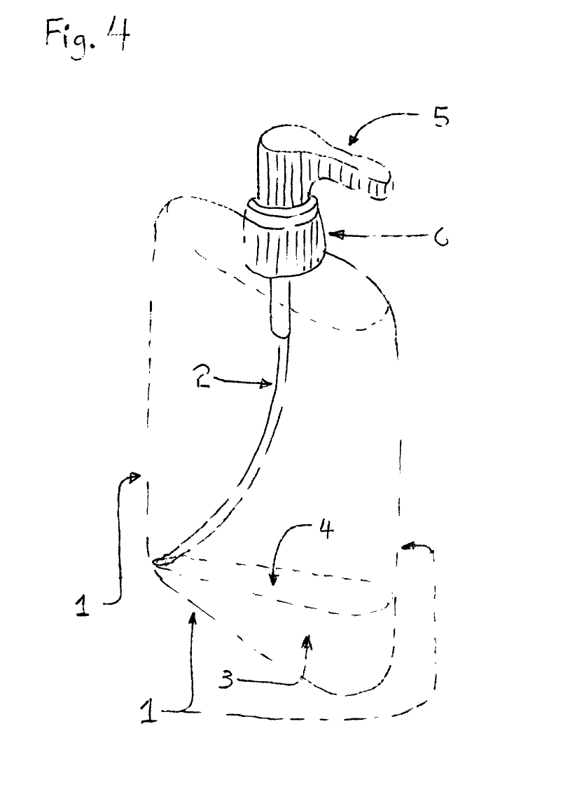

More specifically, it will be noted that the dispenser bottle FIG. 1 is a cut away view of the upright bottle having a conventional finger operated pump. The outer portion of the bottle is represented by number 1. The draw tube number 2 for extracting the contents of bottle number 1 through a leakproof closure cap number 6, via the hand pump dispenser number 5. The triangular feed system number 3 is generally in the shape of a triangle while the platform in this case, number 4 is straight. The bottle may be shaped essentially rectangularity as shown or may have a round, square, oval (see FIG. 4) shape or other configurations as desired.

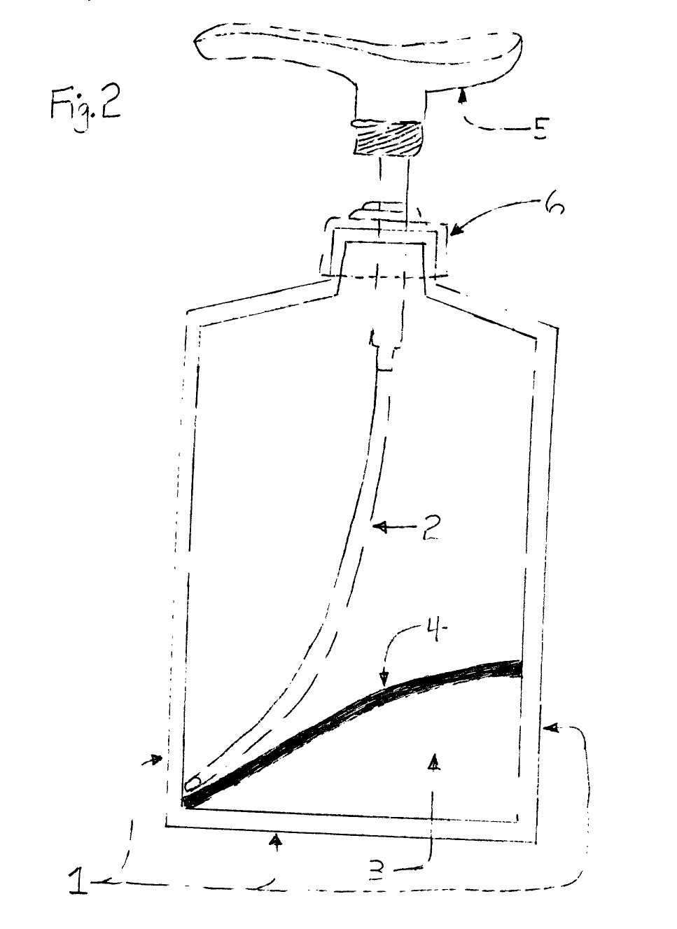

FIG. 2 is a cut away side view of an upright bottle having a conventional hand operated pump number 5. The outer portion of the bottle is represented by number 1. The draw tube number 2 is extracting the contents of bottle number 1 through a leakproof cap number 6, via the hand pump dispenser number 5. The triangular feed system number 3 is generally in the shape of a triangle with the platform in this case, number 4, is made in a convex fashion.

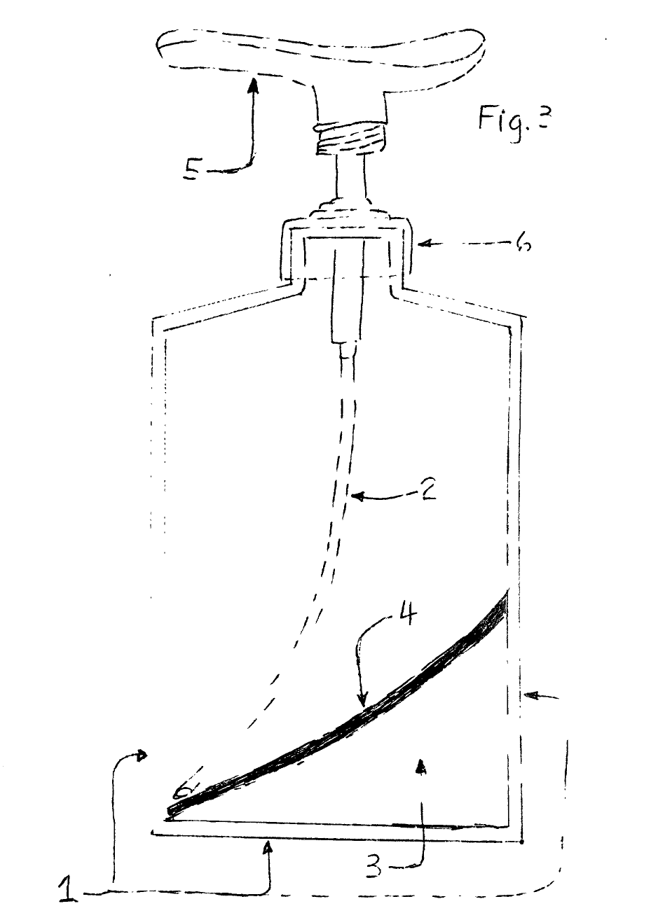

FIG. 3 is a cut away side view of an upright bottle having a conventional hand operated pump number 5. The outer portion of the bottle is represented by number 1. The draw tube number 2 is for extracting the contents of the bottle number 1 through a leakproof cap number 6, via the hand pump dispenser number 5. The triangular feed system number 3 is generally in the shape of a triangle while the platform in this case, number 4, is made in a concave fashion.

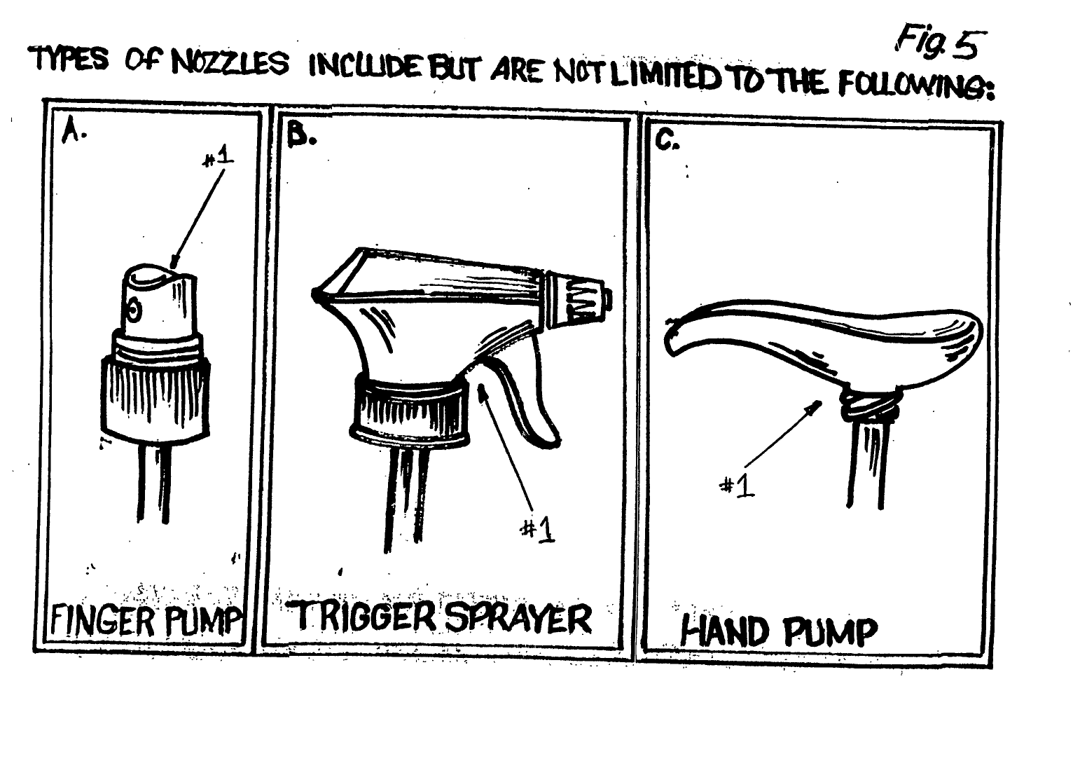

FIG. 4 shows the internal three dimensional view of the present invention. The triangular feed system number 3, that is not limited to any degree of incline, that allows any vicious fluid to flow down the straight, but not limited to and can be concave (see FIG. 3) or convex (see FIG. 2) platform number 4. The fluid then collects at the lowest point of the the triangular feed system and is drawn out by the draw tube number 2 inside bottle number 1. The contents of said bottle is sucked up the draw tube number 2 inside bottle number 1 by the action of the hand operated pump FIG. 5—A number 1, or the other examples given in figure number 5, items A, B and C.

FIG. 5 shows some of the examples of the current more common types of discharging devices known as letter A: Finger Spryer, letter B: Trigger Sprayer and letter C: Hand Pump dispenser. However the present invention is not limited to any new devices that may come alone to dispense viscous substances as mentioned earlier or in the future.

As shown in the FIGURES, the triangular sloped internal base of the bottle number 1 is obviously formed of molded plastic, though other substances such as glass could house the present invention.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only to the principles of the invention. Further, since numerous notifications and changes will readily occur to those skilled in the art, it is not desired to limit the invention to the exact construction and operation shown and described, and accordingly, all suitable modifications and equivalents may be restored to, falling within the scope of the invention.

1. A dispenser bottle comprising:
A: a bottle having a flat exterior base, a sidewall extending around said exterior base and projecting upward to terminate in a neck, with self sealing closure top, which houses the draw tube and dispensing mechanism:
B: at the bottom base of said bottle is housed the triangular shaped feed system which allows the fluid inside said bottle to collect at the lowest most point of said triangular shaped feed system. There it is removed by the draw tube and expelled by the dispensing mechanism leaving little or no fluid left in said bottle.
